(19) United States
(12) Patent Application Publication
(10) Pub. No.: US 2015/0119510 A1
(43) Pub. Date: Apr. 30, 2015

(54) INKJET INK CONTAINING POLYSTYREN COPOLYMER LATEX SUITABLE FOR INDIRECT PRINTING

(71) Applicant: XEROX CORPORATION, NORWALK, CT (US)

(72) Inventors: Jenny Eliyahu, Maple (CA); Daryl W. Vanbesien, Burlington (CA); Michelle N. Chrétien, Mississauga (CA); Marcel Breton, Mississauga (CA); Barkev Keoshkerian, Thornhill (CA)

(73) Assignee: XEROX CORPORATION, NORWALK, CT (US)

(21) Appl. No.: 14/067,469

(22) Filed: Oct. 30, 2013

(51) Int. Cl. C09D 11/00

(52) U.S. Cl. CPC C09D 11/30
USPC 524/167; 524/561

(57) ABSTRACT

An aqueous latex ink comprising a polystyrene copolymer latex, a co-solvent; and a colorant, which is suitable for use in an indirect printing method.

### CROSS-REFERENCE TO RELATED APPLICATIONS

This application is related to co-pending and co-owned U.S. patent application Ser. No. 13/______, entitled “INK JET INK FOR INDIRECT PRINTING APPLICATIONS,” attorney docket 20121666, filed herewith, U.S. patent application Ser. No. 13/______, entitled “PHOTOCURABLE INKS FOR INDIRECT PRINTING,” attorney docket 20130043-0421762, filed herewith, U.S. patent application Ser. No. 13/______, entitled “CURABLE AQUEOUS LATEX INKS FOR INDIRECT PRINTING,” attorney docket 20130044-0421763, filed herewith, U.S. patent application Ser. No. 13/______, entitled “CURABLE LATEX INKS COMPRISING AN UNSATURATED POLYESTER FOR INDIRECT PRINTING,” attorney docket 20130045-0421764, filed herewith, and U.S. patent application Ser. No. 13/______, entitled “EMULSIFIED UV CURABLE INKS FOR INDIRECT PRINTING,” attorney docket 20130052-0421768, filed herewith, each of the foregoing being incorporated herein by reference in its entirety.

### INTRODUCTION

The presently disclosed embodiments are related generally to polystyrene copolymer latex ink compositions for indirect printing method.

Indirect printing process is a two-step printing process wherein the ink is first applied imagewise onto an intermediate receiving member (drum, belt, etc.) using an inkjet printhead. The ink wets and spreads onto the intermediate receiving member to form a transient image. The transient image then undergoes a change in properties (e.g., partial or complete drying, thermal or photo-curing, gelation etc.) and the resulting transient image is then transferred to the substrate.

Inks suitable for such indirect printing process may be designed and optimized to be compatible with the different subsystems, such as, jetting, transfer, etc., that enable high quality printing at high speed. Typically, inks that display good wettability do not transfer onto a substrate, or conversely inks that transfer efficiently to the substrate do not wet the intermediate receiving member. To date, there appears to be no known commercially available ink that enables both the wetting and the transfer functions.

Thus, there exists a need to develop an ink suitable for indirect printing process, and particularly, there exists a need to develop an ink that exhibits good wetting of the intermediate receiving member and is capable of efficient transfer to the final substrate.

Each of the foregoing U.S. patents and patent publications are incorporated by reference herein in their entirety. Further, the appropriate components and process aspects of the each of the foregoing U.S. patents and patent publications may be selected for the present disclosure in embodiments thereof.

### SUMMARY

According to embodiments illustrated herein, there is provided novel ink compositions comprising an aqueous latex ink for use in an indirect printing process comprising a polystyrene copolymer latex; a co-solvent; and a colorant; wherein the ink has a surface tension of from about 18 to about 35 mN/m, and has a viscosity of from about 2 centipoise to about 20 centipoise at 30° C.

In particular, the present embodiments provide an aqueous latex ink for use in an indirect printing process comprising a polystyrene copolymer latex comprising an alkyl acrylate, wherein the alkyl portion of the alkyl acrylate contains from 1 to 18 carbon atoms; co-solvent; and a colorant; wherein the ink has a surface tension of from about 18 to about 35 mN/m.

In further embodiments, there is provided an aqueous latex ink for use in an indirect printing process comprising a polystyrene copolymer latex comprising an alkyl acrylate, wherein the alkyl portion of the alkyl acrylate contains from 1 to 18 carbon atoms; wherein the polyester polymer latex is present in an amount of from about 3 weight percent to about 20 weight percent based on the total weight of the ink; co-solvent; and a colorant; wherein the ink has a surface tension of from about 18 to about 35 mN/m.

### BRIEF DESCRIPTION OF THE DRAWINGS

For a better understanding of the present embodiments, reference may be made to the accompanying figures.

FIG. 1 is a diagrammatical illustration of an imaging member in accordance with the present embodiments for applying a two-step transfer and curing process in an indirect printing system.

### DETAILED DESCRIPTION

In the following description, it is understood that other embodiments may be utilized and structural and operational changes may be made without departure from the scope of the present embodiments disclosed herein.

In this specification and the claims that follow, singular forms such as “a,” “an,” and “the” include plural forms unless the content clearly dictates otherwise. All ranges disclosed herein include, unless specifically indicated, all endpoints and intermediate values. In addition, reference may be made to a number of terms that shall be defined as follows:

As used herein, the term “viscosity” refers to a complex viscosity, which is the typical measurement provided by a mechanical rheometer that is capable of subjecting a sample to a steady shear strain or a small amplitude sinusoidal deformation. In this type of instrument, the shear strain is applied by the operator to the motor and the sample deformation (torque) is measured by the transducer. Examples of such instruments are the Rheometrics Fluid Rheometer RFS3 or the ARES G2 Rheometer both made by Rheometrics, a division of TA Instruments. Disclosed herein is an aqueous latex ink which is suitable for an indirect print process, or indirect printing ink jet applications. The aqueous latex ink of the present embodiments may possess the required surface tension (in the range of 15-50 mN/m), viscosity (in the range of 3-20 cPs), and particle size (<600 nm) for use in an inkjet (e.g., piezoelectric) printhead.

In embodiments, the aqueous latex ink has a surface tension of from about 18 mN/m to about 40 mN/m, for example from about 18 mN/m to about 35 mN/m, or from about 20 mN/m to about 30 mN/m. In embodiments, the aqueous latex ink has a viscosity of from about 2 cps to about 20 cps, for example from about 2 cPs, to about 15 cps, or from about 4 cps to about 12 cps, or less than about 10 cps at the temperature of jetting. In particular embodiments, the ink compositions are jetted at temperatures of less than about 80° C., such as from about 25° C. to about 80° C., or from about 30° C. to about 50° C., such as from about 30° C. to about 40° C.

In embodiments, the aqueous latex ink has a volume average pigment particle size of less than about 600 nm, for example from about 25 nm to about 500 nm, or from about 50 nm to about 300 nm, or less than about 150 nm.

In embodiments, the curable aqueous latex ink has a volume average latex particle size of less than about 600 nm, for example from about 50 nm to about 600 nm, or from about 50 nm to about 500 nm, or from about 50 nm to about 300 nm.

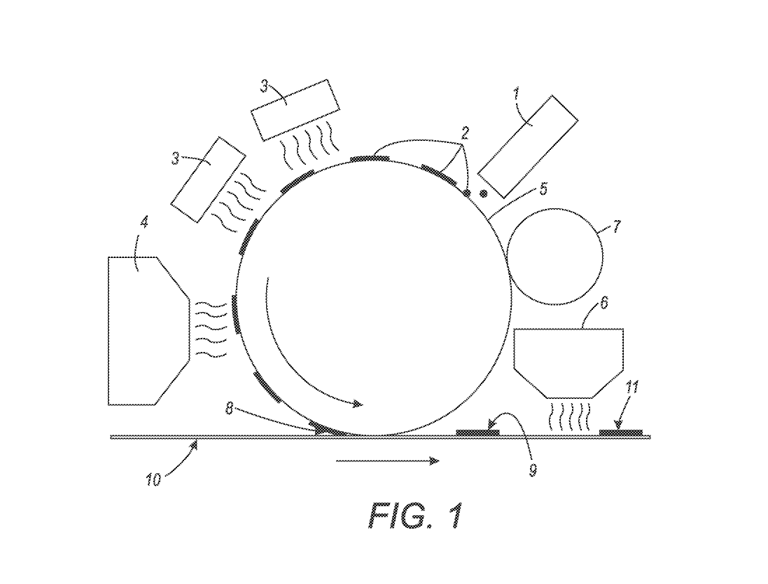

FIG. 1 discloses a diagrammatical illustration of an imaging system in accordance with the present embodiments for applying a two-step transfer and curing process whereby an ink of the present disclosure is printed onto an intermediate transfer surface for subsequent transfer to a receiving substrate. During the indirect print process, the ink of the present embodiments is jetted and spread onto an intermediate receiving member 5 via an inkjet printhead 1. The intermediate receiving member 5 may be provided in the form of a drum, as shown in FIG. 1, but may also be provided as a web, platen, belt, band or any other suitable design.

Referring again to FIG. 1, the intermediate receiving member 5 may be heated by a heater device 3 to remove the water content (partial or full) in the ink vehicle of ink 2, and induce film formation by the residual ink which includes latex and curable materials (e.g., monomers/oligomers). The residual ink is optionally partially cured (pre-cured) by heater 4 to reduce film splitting prior to the transfer of the ink image 8. The ink image 8 is then transferred from the intermediate receiving member 5 to the final receiving substrate 10. The transfer of the ink image may be performed through contact under pressure, and/or near the softening point of the latex of the ink. The transferred image 9 is then further subjected to heat 6 resulting in a robust image 11. Image robustness is especially important for packaging applications such as folding carton, for example.

An ink suitable for an indirect printing process should be able to wet the intermediate receiving member 5 to enable formation of the transient image 8, and undergo a stimulus induced property change to enable release from the intermediate receiving member 5 in the transfer step.

Latexes

The aqueous latex ink of the present embodiments includes a polystyrene copolymer latex. The polystylene copolymer latex comprises (or can be derived from) styrene monomer and one or more co-monomers such as alkyl acrylate, alkyl methacrylate, alkyl acrylate-acrylic acid, 1,3-diene-acrylic acid, alkyl methacrylate-acrylic acid, alkyl methacrylate-alkyl acrylate, alkyl methacrylate-aryl acrylate, aryl methacrylate-alkyl acrylate, alkyl methacrylate-acrylic acid. In certain embodiments, the co-monomer is selected from among acrylates, methacrylates and mixtures thereof. In certain embodiments, the copolymer is comprised of styrene monomer and an alkyl acrylate. In one embodiment, the copolymer is comprised of styrene monomer and butyl acrylate, e.g., n-butyl acrylate, monomer. In further embodiments, the copolymer further includes an amount of β-carboxyethyl acrylate (β-CEA).

In certain embodiments, the polystyrene copolymer latex includes an acrylic emulsion latex, obtained from alkyl acrylates having alkyl groups of from 1 to 18 carbon atoms, from 1 to 6 carbon atoms, or from 1 to 4 carbon atoms.

The polystyrene copolymer latex may be crosslinked. This may be done by including one or more crosslinking monomers. Crosslinking monomers may include, for example, divinylbenzene or diethylene glycol methacrylate. The crosslinking monomer(s) may be included in effective amounts, for example from about 0.01 to about 20 percent by weight of the polymer. A crosslinked resin thus refers, for example, to a crosslinked resin or gel comprising, for example, about 0.3 to about 20 percent crosslinking.

In embodiments, a weight ratio of the styrene monomer to the co-monomer is from about 1:0.1 to about 1:10, although the amount can be outside of these ranges. In further embodiments, the ratio is from about from about 1:1 to about 1:6, from about 1:1.2 to about 1:5, or from about 1:5 to about 1:3.5. In embodiments, the styrene monomer is present in an amount of from 55 to about 95 percent, or of from 65 to about 85 percent, or of from 75 to about 82 percent by weight of the total weight of the ink composition, although the amount can be outside of these ranges.

The polystyrene copolymer latex of the present embodiments may have a glass transition temperature (Tg) in the range of from about 40° C. to about 70° C., from about 50° C. to about 65° C., from about 55° C. to about 63° C.

The polystyrene copolymer latex of the present embodiments may have a weight average molecular weight (Mw) of from about 10,000 g/mol to about 100,000 g/mol, in embodiments from about 15,000 g/mol to about 60,000 g/mol, or from about 20,000 g/mol to about 45,000 g/mol.

The polystyrene copolymer latex of the present embodiments may have an average particle size of from about 50 to about 600 nm, from about 50 to about 500 nm, or from about 50 to about 300 nm.

The total amount of polystyrene copolymer latex included in the ink composition may be from, for example, about 3 percent to about 20 percent by weight, such as from about 4 percent to about 15 percent, or from about 5 percent to about 10 percent by weight of the ink composition.

Water and Co-Solvent

The ink vehicle compositions herein can comprise solely water, or can comprise a mixture of water and a water soluble or water miscible organic component, referred to as a co-solvent, humectant, or the like (hereinafter co-solvent) such as alcohols and alcohol derivatives, including aliphatic alcohols, aromatic alcohols, dials, glycol ethers, polyglycol ethers, long chain alcohols, primary aliphatic alcohols, secondary aliphatic alcohols, 1,2-alcohols, 1,3-alcohols, 1,5-alcohols, ethylene glycol alkyl ethers, propylene glycol alkyl ethers, methoxylated glycerol, ethoxylated glycerol, higher homologues of polyethylene glycol alkyl ethers, and the like, with specific examples including ethylene glycol, propylene glycol, diethylene glycols, glycerine, dipropylene glycols, polyethylene glycols, polypropylene glycols, trimethylolpropane, 1,5-pentanediol, 2-methyl-1,3,-propanediol, 2-ethyl-2-hydroxymethyl-1,3-propanediol, 3-methoxybutanol, 3-methyl-1,5-pentanediol, 1,3-propanediol, 1,4-butanediol, 2,4-heptanediol, and the like; also suitable are amides, ethers, urea, substituted ureas such as thiourea, ethylene urea, alkylurea, alkylthiourea, dialkylurea, and dialkylthiourea, carboxylic acids and their salts, such as 2-methylpentanoic acid, 2-ethyl-3-propylacrylic acid, 2-ethyl-hexanoic acid, 3-ethoxyproponic, acid, and the like, esters, organosulfides, organosulfoxides, sulfones (such as sulfolane), carbitol, butyl carbitol, cellusolve, ethers, tripropylene glycol monomethyl ether, ether derivatives, hydroxyethers, amino alcohols, ketones, N-methylpyrrolidinone, 2-pyrrolidinone, cyclohexylpyrrolidone, amides, sulfoxides, lactones, polyelectrolytes, methyl sulfonylethanol, imidazole, 1,3-dimethyl-2-imidazolidinone, betaine, sugars, such as 1-deoxy-D-galactitol, mannitol, inositol, and the like, substituted and unsubstituted formamides, substituted and unsubstituted acetamides, and other water soluble or water miscible materials, as well as mixtures thereof. In embodiments, the co-solvent is selected from the group consisting of ethylene glycol, N-methylpyrrolidone, methoxylated glycerol, ethoxylated glycerol, and mixtures thereof.

The ink of the present disclosure may comprise from about 30 weight percent to about 70 weight percent, from about 40 weight percent to about 60 weight percent, or from about 50 weight percent to about 55 weight percent of water based on the total weight of the ink.

When mixtures of water and water soluble or miscible organic liquids are selected as the liquid vehicle, the water to organic ratio ranges can be any suitable or desired ratio, in embodiments from about 100:0 to about 30:70, or from about 97:3 to about 40:60, or from about 95:5 to about 60:40. The non-water component of the liquid vehicle generally serves as a humectant or co-solvent which has a boiling point higher than that of water (100° C. at 1 atm). The organic component of the ink vehicle can also serve to modify ink surface tension, modify ink viscosity, dissolve or disperse the colorant, and/or affect the drying characteristics of the ink.

In certain embodiments, the co-solvent is selected from the group consisting of sulfolane, methyl ethyl ketone, isopropanol, 2-pyrrolidinone, polyethylene glycol, and mixtures thereof.

The total amount of liquid vehicle can be provided in any suitable or desired amount. In embodiments, the liquid vehicle is present in the aqueous latex composition in an amount of from about 75 to about 97 percent, or from about 80 to about 95 percent, or from about 85 to about 95 percent, by weight, based on the total weight of the aqueous latex ink composition.

Colorants

In embodiments, the colorant may include a pigment, a dye, combinations thereof, black, cyan, magenta, yellow, red, green, blue, brown, combinations thereof, in an amount sufficient to impart the desired color to the ink.

The colorant may be provided in the form of a colorant dispersion. In embodiments, the colorant dispersion has an average particle size of from about 20 to about 500 nanometers (nm), or from about 20 to about 400 nm, or from about 30 to about 300 nm. In embodiments, the colorant is selected from the group consisting of dyes, pigments, and combinations thereof, and optionally, the colorant is a dispersion comprising a colorant, an optional surfactant, and an optional dispersant.

As noted, any suitable or desired colorant can be selected in embodiments herein. The colorant can be a dye, a pigment, or a mixture thereof. Examples of suitable dyes include anionic dyes, cationic dyes, nonionic dyes, zwitterionic dyes, and the like. Specific examples of suitable dyes include Food dyes such as Food Black No. 1, Food Black No. 2, Food Red No. 40, Food Blue No. 1, Food Yellow No. 7, and the like, FD & C dyes, Acid Black dyes (No. 1, 7, 9, 24, 26, 48, 52, 58, 60, 61, 63, 92, 107, 109, 118, 119, 131, 140, 155, 156, 172, 194, and the like), Acid Red dyes (No. 1, 8, 32, 35, 37, 52, 57, 92, 115, 119, 154, 249, 254, 256, and the like), Acid Blue dyes (No. 1, 7, 9, 25, 40, 45, 62, 78, 80, 92, 102, 104, 113, 117, 127, 158, 175, 183, 193, 209, and the like), Acid Yellow dyes (No. 3, 7, 17, 19, 23, 25, 29, 38, 42, 49, 59, 61, 72, 73, 114, 128, 151, and the like), Direct Black dyes (No. 4, 14, 17, 22, 27, 38, 51, 112, 117, 154, 168, and the like), Direct Blue dyes (No. 1, 6, 8, 14, 15, 25, 71, 76, 78, 80, 86, 90, 106, 108, 123, 163, 165, 199, 226, and the like), Direct Red dyes (No. 1, 2, 16, 23, 24, 28, 39, 62, 72, 236, and the like), Direct Yellow dyes (No. 4, 11, 12, 27, 28, 33, 34, 39, 50, 58, 86, 100, 106, 107, 118, 127, 132, 142, 157, and the like), Reactive Dyes, such as Reactive Red Dyes (No. 4, 31, 56, 180, and the like), Reactive Black dyes (No. 31 and the like), Reactive Yellow dyes (No. 37 and the like); anthraquinone dyes, monoazo dyes, disazo dyes, phthalocyanine derivatives, including various phthalocyanine sulfonate salts, aza(18)annulenes, formazan copper complexes, triphenodioxazines, and the like; and the like, as well as mixtures thereof.

Examples of suitable pigments include black pigments, white pigments, cyan pigments, magenta pigments, yellow pigments, or the like. Further, pigments can be organic or inorganic particles. Suitable inorganic pigments include carbon black. However, other inorganic pigments may be suitable such as titanium oxide, cobalt blue (CoO—Al₂O₃), chrome yellow (PbCrO₄), and iron oxide. Suitable organic pigments include, for example, azo pigments including diazo pigments and monoazo pigments, polycyclic pigments (e.g., phthalocyanine pigments such as phthalocyanine blues and phthalocyanine greens), perylene pigments, perinone pigments, anthraquinone pigments, quinacridone pigments, dioxazine pigments, thioindigo pigments, isoindolinone pigments, pyranthrone pigments, and quinophthalone pigments), insoluble dye chelates (e.g., basic dye type chelates and acidic dye type chelate), nitro pigments, nitroso pigments, anthanthrone pigments such as PR168, and the like. Representative examples of phthalocyanine blues and greens include copper phthalocyanine blue, copper phthalocyanine green, and derivatives thereof (Pigment Blue 15, Pigment Green 7, and Pigment Green 36). Representative examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19, and Pigment Violet 42. Representative examples of anthraquinones include Pigment Red 43, Pigment Red 194, Pigment Red 177, Pigment Red 216 and Pigment Red 226. Representative examples of perylenes include Pigment Red 123, Pigment Red 149, Pigment Red 179, Pigment Red 190, Pigment Red 189 and Pigment Red 224. Representative examples of thioindigoids include Pigment Red 86, Pigment Red 87, Pigment Red 88, Pigment Red 181, Pigment Red 198, Pigment Violet 36, and Pigment Violet 38. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213. Such pigments are commercially available in either powder or press cake form from a number of sources including, BASF Corporation, Engelhard Corporation, and Sun Chemical Corporation. Examples of black pigments that may be used include carbon pigments. The carbon pigment can be almost any commercially available carbon pigment that provides acceptable optical density and print characteristics. Carbon pigments suitable for use in the present system and method include, without limitation, carbon black, graphite, vitreous carbon, charcoal, and combinations thereof. Such carbon pigments can be manufactured by a variety of known methods, such as a channel method, a contact method, a furnace method, an acetylene method, or a thermal method, and are commercially available from such vendors as Cabot Corporation, Columbian Chemicals Company, Evonik, and E.I. DuPont de Nemours and Company. Suitable carbon black pigments include, without limitation, Cabot pigments such as MONARCH 1400, MONARCH 1300, MONARCH 1100, MONARCH 1000, MONARCH 900, MONARCH 880, MONARCH 800, MONARCH 700, CAB-O-JET 200, CAB-O-JET 300, REGAL, BLACK PEARLS, ELFTEX, MOGUL, and VULCAN pigments; Columbian pigments such as RAVEN 5000, and RAVEN 3500; Evonik pigments such as Color Black FW 200, FW 2, FW 2V, FW 1, FW18, FW S160, FW S170, Special Black 6, Special Black 5, Special Black 4A, Special Black 4, PRINTEX U, PRINTEX 140U, PRINTEX V, and PRINTEX 140V. The above list of pigments includes unmodified pigment particulates, small molecule attached pigment particulates, and polymer-dispersed pigment particulates. Other pigments can also be selected, as well as mixtures thereof. The pigment particle size is desired to be as small as possible to enable a stable colloidal suspension of the particles in the liquid vehicle and to prevent clogging of the ink channels when the ink is used in a thermal ink jet printer or a piezoelectric ink jet printer.

In embodiments, the colorant may be included in the ink in an amount of, for example, about 0.1 to about 35% by weight of the ink, or from about 1 to about 15% by weight of the ink, or from about 2 to about 10% by weight of the ink. In some embodiments, the ink is substantially void of colorants.

Surfactant

The inks disclosed may also contain a surfactant. Examples of suitable surfactants include ionic surfactants, anionic surfactants, cationic surfactants, nonionic surfactants, zwitterionic surfactants, and the like, as well as mixtures thereof. Examples of suitable surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like, with specific examples including primary, secondary, and tertiary amine salt compounds such as hydrochloric acid salts, acetic acid salts of laurylamine, coconut amine, stearylamine, rosin amine; quaternary ammonium salt type compounds such as lauryltrimethylammonium chloride, cetyltrimethylammonium chloride, benzyltributylammonium chloride, benzalkonium chloride, etc.; pyridinium salty type compounds such as cetylpyridinium chloride, cetylpyridinium bromide, etc.; nonionic surfactant such as polyoxyethylene alkyl ethers, polyoxyethylene alkyl esters, acetylene alcohols, acetylene glycols; and other surfactants such as 2-heptadecenyl-hydroxyethylimidazoline, dihydroxyethylstearylamine, stearyldimethylbetaine, and lauryldihydroxyethylbetaine; fluorosurfactants; and the like, as well as mixtures thereof. Additional examples of nonionic surfactants include polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenc as IGEPAL CA-210™ IGEPAL CA-520™, IGEPAL CA-720™, IGEPAL CO-890™, IGEPAL C0-720™, IGEPAL C0-290™, IGEPAL CA-21O™, ANTAROX 890™, and ANTAROX 897™. Other examples of suitable nonionic surfactants include a block copolymer of polyethylene oxide and polypropylene oxide, including those commercially available as SYNPERONIC™ PE/F, such as SYNPERONIC™ PE/F 108. Other examples of suitable anionic surfactants include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Sigma-Aldrich, NEOGEN R™, NEOGEN SC™ available from Daiichi Kogyo Seiyaku, combinations thereof, and the like. Other examples of suitable anionic surfactants include DOWFAX™ 2A1, an alkyldiphenyloxide disulfonate from Dow Chemical Company, and/or TAYCA POWER BN2060 from Tayca Corporation (Japan), which are branched sodium dodecyl benzene sulfonates. Other examples of suitable cationic surfactants, which are usually positively charged, include alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C12, C15, C17 trimethyl ammonium bromides, halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, as well as mixtures thereof. Mixtures of any two or more surfactants can be used.

The optional surfactant can be present in any desired or effective amount, in embodiments, the surfactant is present in an amount of from about 0.01 to about 5 percent by weight, based on the total weight of the ink composition. It should be noted that the surfactants are named as dispersants in some cases.

Additives

The ink composition can further comprise additives. Optional additives that can be included in the ink compositions include biocides, fungicides, pH controlling agents such as acids or bases, phosphate salts, carboxylates salts, sulfite salts, amine salts, buffer solutions, and the like, sequestering agents such as EDTA (ethylenediamine tetra acetic acid), viscosity modifiers, leveling agents, and the like, as well as mixtures thereof.

In embodiments, the ink composition is a low-viscosity composition. The term “low-viscosity” is used in contrast to conventional high-viscosity inks such as screen printing inks, which tend to have a viscosity of at least 1,000 centipoise (cps). In specific embodiments, the ink disclosed herein has a viscosity of no more than about 100 cps, no more than about 50 cps, or no more than about 20 cps, or from about 2 to about 30 cps at a temperature of about 30° C., although the viscosity can be outside of these ranges. When used in ink jet printing applications, the ink compositions are generally of a viscosity suitable for use in said ink jet printing processes. For example, for thermal ink jet printing applications, at room temperature (i.e., about 25° C.), the ink viscosity is at least about 1 centipoise, no more than about 10 centipoise, no more than about 7 centipoise, or no more than about 5 centipoise, although the viscosity can be outside of these ranges. For piezoelectric ink jet printing, at the jetting temperature, the ink viscosity is at least about 2 centipoise, at least about 3 centipoise, no more than about 20 centipoise, no more than about 15 centipoise, or no more than about 10 centipoise, although the viscosity can be outside of these ranges. The jetting temperature can be as low as about 20 to 25° C., and can be as high as about 70° C., as high as about 50° C., or as high as about 40° C., although the jetting temperature can be outside of these ranges.

In certain embodiments, the ink compositions herein have a viscosity of from about 2 to about 20 centipoise at a temperature of about 30° C.

The ink compositions herein have selected surface tension characteristics that provide wetting and release properties suitable for indirect printing applications. In embodiments, the ink composition is selected to provide a surface tension, viscosity, and particle size that is suitable for use in a piezoelectric ink jet print head.

In embodiments, the ink composition herein has a surface tension of from about 15 to about 50 mN/m, or from about 18 to about 38 mN/m, or from about 20 to about 35 mN/m, although the surface tension can be outside of these ranges.

Ink Preparation

The inks of embodiments may be prepared by any suitable technique and process, such as by simple mixing of the ingredients. One process entails mixing all of the ink ingredients together and filtering the mixture to obtain an ink. Inks can be prepared by mixing the ingredients, heating if desired, and filtering, followed by adding any desired additional additives to the mixture and mixing at room temperature with moderate shaking until a homogeneous mixture is obtained, in one embodiment from about 5 to about 10 minutes. Alternatively, the optional ink additives can be mixed with the other ink ingredients during the ink preparation process, which takes place according to any desired procedure, such as by mixing all the ingredients and filtering. Further examples of ink preparation methods are set forth in the Examples below.

In a specific embodiment, the inks are prepared as follows: 1) preparation of a polystyrene latex optionally stabilized with a surfactant; 2) preparation of a dispersion of a colorant optionally stabilized with a dispersant and/or surfactant; 3) mixing of the polystyrene latex with the colorant dispersion; 4) optional filtering of the mixture; 5) addition of other components such as water, co-solvents, humectant, photoinitiators and optional additives; and 6) optional filtering of the composition.

Also disclosed herein is a process which comprises applying an ink composition as disclosed herein to a substrate in an imagewise pattern.

The ink compositions can be used in a process which entails incorporating the ink composition into an ink jet printing apparatus and causing droplets of the ink to be ejected in an imagewise pattern onto a substrate. In a specific embodiment, the printing apparatus employs a thermal ink jet process wherein the ink in the nozzles is selectively heated in an imagewise pattern, thereby causing droplets of the ink to be ejected in imagewise pattern. In another embodiment, the printing apparatus employs an acoustic ink jet process wherein droplets of the ink are caused to be ejected in imagewise pattern by acoustic beams. In yet another embodiment, the printing apparatus employs a piezoelectric ink jet process, wherein droplets of the ink are caused to be ejected in imagewise pattern by oscillations of piezoelectric vibrating elements. Any suitable substrate can be employed.

In a specific embodiment, a process herein comprises incorporating an ink prepared as disclosed herein into an ink jet printing apparatus, ejecting ink droplets in an imagewise pattern onto an intermediate transfer member, optionally heating the image to partially or completely remove solvents, and transferring the ink in the imagewise pattern from the intermediate transfer member to a final recording substrate. In a specific embodiment, the intermediate transfer member is heated to a temperature above that of the final recording sheet and below that of the ink in the printing apparatus. An offset or indirect printing process is also disclosed in, for example, U.S. Pat. No. 5,389,958, the disclosure of which is totally incorporated herein by reference. In one specific embodiment, the printing apparatus employs a piezoelectric printing process wherein droplets of the ink are caused to be ejected in imagewise pattern by oscillations of piezoelectric vibrating elements.

Any suitable substrate or recording sheet can be employed as the final recording sheet, including plain papers such as XEROX® 4024 papers, XEROX® Image Series papers, Courtland 4024 DP paper, ruled notebook paper, bond paper, silica coated papers such as Sharp Company silica coated paper, JuJo paper, HAMMERMILL LASERPRINT® paper, and the like, transparency materials, fabrics, textile products, plastics, polymeric films, inorganic substrates such as metals and wood, and the like.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example 1

### Preparation of Latex A

A latex emulsion (Latex A) comprised of polymer particles generated from the emulsion polymerization of styrene, n-butyl acrylate and β-CEA (2-carboxyethyl acrylate) was prepared as follows. A surfactant solution of 605 grams Dowfax 2A1 (anionic emulsifier) and 387 kg de-ionized water was prepared by mixing for 10 minutes in a stainless steel holding tank. The holding tank was then purged with nitrogen for 5 minutes before transferring into the reactor. The reactor was then continuously purged with nitrogen while being stirred at 100 RPM. The reactor was then heated up to 80° C. at a controlled rate, and held there. Separately 6.1 kg of ammonium persulfate initiator was dissolved in 30.2 kg of de-ionized water.

Separately the monomer emulsion was prepared in the following manner. 323 kg of styrene, 83 kg of butyl acrylate and 12.21 kg of β-CEA, 2.85 kg of 1-dodecanethiol, 1.42 kg of decane-1,10-diacrylate (ADOD), 8.04 kg of Dowfax 2A1 (anionic surfactant), and 193 kg of deionized water were mixed to form an emulsion. 1% of the above emulsion is then slowly fed into the reactor containing the aqueous surfactant phase at 80° C. to form the “seeds” while being purged with nitrogen. The initiator solution is then slowly charged into the reactor and after 10 minutes the rest of the emulsion is continuously fed in a using metering pump at a rate of 0.5%/min. After 100 minutes, half of the monomer emulsion has been added to the reactor. At this time, 3.42 kg of 1-dodecanethiol is stirred into the monomer emulsion, and the emulsion is continuously fed in at a rate of 0.5%/min. Also at this time the reactor stirrer is increased to 350 RPM. Once all the monomer emulsion is charged into the main reactor, the temperature is held at 80° C. for an additional 2 hours to complete the reaction. Full cooling is then applied and the reactor temperature is reduced to 35° C. The product is collected into a holding tank. The particle size was calculated to be 180 nm. After drying the latex the molecular properties were measured to be Mw=37,500, Mn=10,900, and the onset Tg was 55.0° C.

### Example 2

### Ink Formulation A

To a 50 mL amber glass vial was added surfactant and carbon black dispersion, while the mixture was stirred with a magnetic stir bar at 200 RPM, water (−20% to wash latex beaker) was slowly added. The pH of the latex was separately adjusted to 6.8 and then slowly added to vial which was chased with 20% water to clean latex's residuals. The ink was then homogenized for 5 minutes at 2000 RPM. Table 1 below shows the components of Ink Formulation A.

TABLE 1

| | | Solids | | Actual |
|---|---|---|---|---|
| | | Weight | Solid (of | mass |
| Ink A | | Percent in | stock | in |
| Component | Function | INK | solution) | grams |
| Latex A | | 10.00% | 41.06% | 12.177 |
| Sulfolane | co-solvent | 15.84% | 95.00% | 8.337 |
| 2-pyrrolidinone | co-solvent | 3.33% | 100.00% | 1.665 |
| Poly(ethylene glycol) | Viscosity | 0.72% | 100.00% | 0.360 |
| (Mw 20K) | modifier | | | |
| Carbon Black 300 | pigment | 3.30% | 14.87% | 11.096 |
| Dowicil 75 | preservative | 0.10% | 100% | 0.050 |
| FS8050 | Surfactant | 0.161% | 100% | 0.081 |
| Water | | 52.03% | 100.00% | 16.234 |
| TOTAL | | | | 50.000 |

### Example 3

### Ink Characteristics

Rheology: Flow Sweep was performed using an Ares G2 controlled strain rheometer from TA Instruments equipped with a 50 mm parallel plate geometry. The resulting Ink A displayed favorable rheology, having viscosities below 10 cps at jetting temperature (e.g., measured as 5 cps at 32° C.).

Particle size: The pigment particle size was measured to be below 150 nm (or from 100 nm to 300 nm) using a dynamic light scattering technique such as with a Malvern Zetasizer particle size analyzer.

Surface tension: A sample of Ink A was measured on a K-100 Surface Tensiometer available from Kruss, equipped with a Wilhelmy plate at room temperature, about 27° C. Surface tension data was determined to be an average of 20 data points taken from 1 s to 60 s (e.g., measured at 21.7 mN/m).

### Example 4

### Jetting and Transfer

Ink A was jetted onto a fluorinated silicone blanket material described in U.S. Pat. No. 6,434,355, the disclosure of which is totally incorporated herein by reference, dried, and then pulled off (transferred) using adhesive tape. This process mimics an in-direct print process by using adhesive tape in place of a heated substrate (such as coated paper) and heated blanket. The results demonstrated that Ink A was easily jetted onto the blanket using a Dimatix printer (DMP 2800), and easily and fully transferred onto adhesive tape.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

What is claimed is:

1. An aqueous latex ink for use in an indirect printing process comprising:
a polystyrene copolymer latex;
a co-solvent; and
a colorant;
wherein the ink has a surface tension of from about 18 to about 35 mN/m, and has a viscosity of from about 2 centipoise to about 20 centipoise at about 30° C.

2. The ink of claim 1, wherein the polystyrene copolymer latex comprises a styrene monomer and a co-monomer.

3. The ink of claim 2, wherein the co-monomer is selected from the group consisting of alkyl acrylate, alkyl methacrylate, alkyl acrylate-acrylic acid, 1,3-diene-acrylic acid, alkyl methacrylate-acrylic acid, alkyl methacrylate-alkyl acrylate, alkyl methacrylate-aryl acrylate, aryl methacrylate-alkyl acrylate, alkyl methacrylate-acrylic acid, and mixtures thereof.

4. The ink of claim 2, wherein the co-monomer comprises an alkyl acrylate.

5. The ink of claim 4, wherein the alkyl portion of the alkyl acrylate contains from 1 to 18 carbon atoms.

6. The ink of claim 4, wherein the alkyl acrylate is n-butyl acrylate.

7. The ink of claim 2, wherein the weight ratio of the styrene monomer to the co-monomer is from about 1:0.1 to about 1:10.

8. The ink of claim 1, wherein the polystyrene copolymer latex has a weight average molecular weight of from about 10,000 g/mol to about 100,000 g/mol.

9. The ink of claim 1, wherein the polyester polymer latex has a glass transition temperature of from about 45° C. to about 70° C.

10. The ink of claim 1, wherein the polystyrene copolymer latex has an average particle size of from about 50 nm to about 300 nm.

11. The ink of claim 1, wherein the polyester polymer latex is present in an amount of from about 3 weight percent to about 20 weight percent based on the total weight of the ink.

12. The ink of claim 1, wherein the co-solvent comprises sulfone.

13. The ink of claim 1, wherein the colorant is selected from the group consisting of pigment, dye, mixtures of pigment and dye, mixtures of pigments, and mixtures of dyes.

14. The ink of claim 1, wherein the ink comprises from about 40 weight percent to about 60 weight percent of water based on the total weight of the ink.

15. An aqueous latex ink for use in an indirect printing process comprising:
a polystyrene copolymer latex comprising an alkyl acrylate, wherein the alkyl portion of the alkyl acrylate contains from 1 to 18 carbon atoms;
co solvent; and
a colorant;
wherein the ink has a surface tension of from about 18 to about 35 mN/m.

16. The ink of claim 15, wherein the polystyrene copolymer latex has a weight average molecular weight of from about 10,000 g/mol to about 100,000 g/mol.

17. The ink of claim 15, wherein the alkyl acrylate is n-butyl acrylate.

18. The ink of claim 1, wherein the ink comprises from about 30 weight percent to about 70 weight percent of water based on the total weight of the ink.

19. An aqueous latex ink for use in an indirect printing process comprising:
a polystyrene copolymer latex comprising an alkyl acrylate, wherein the alkyl portion of the alkyl acrylate contains from 1 to 18 carbon atoms; wherein the polyester polymer latex is present in an amount of from about 3 weight percent to about 20 weight percent based on the total weight of the ink;
co solvent; and
a colorant;
wherein the ink has a surface tension of from about 18 to about 35 mN/m.

20. The ink of claim 19, wherein the polystyrene copolymer latex has a weight average molecular weight of from about 10,000 g/mol to about 100,000 g/mol.
